(19) United States
(12) Patent Application Publication
(10) Pub. No.: US 2023/0142161 A1
(43) Pub. Date: May 11, 2023

(54) RESPONSE ABSTRACTION AND MODEL SIMPLIFICATION TO IDENTIFY INTERESTING DATA

(71) Applicant: Architecture Technology Corporation, Minneapolis, MN (US)

(72) Inventors: Paul Nicotera, Ithaca, NY (US); Scott Aloisio, Willseyville, NY (US); Yuliy Tsank, Sunnyvale, CA (US)

(21) Appl. No.: 17/930,634

(22) Filed: Sep. 8, 2022

Related U.S. Application Data
(60) Provisional application No. 63/277,019, filed on Nov. 8, 2021.
(60) Provisional application No. 63/281,070, filed on Nov. 18, 2021.

(51) Int. Cl. G06N 3/04; H04L 67/12

(52) U.S. Cl. CPC G06N 3/0427; H04L 67/12

(57) ABSTRACT

A sensor platform includes a memory, a sensor interface communicatively coupled to the memory and one or more processors communicatively coupled to the memory. The memory stores instructions for generating event detection models used to detect events in captured sensor data. The sensor interface is configured to capture data received from sensors connected to the sensor interface and to store the captured sensor data in the memory. The one or more processors are configured to generate an event detection model from the instructions, the event detection model trained to detect an event from within the captured sensor data, to transmit notice of the detected event to a remote observer and to transmit the captured sensor data associated with the detected event in response to a request from the remote observer for sensor data corresponding to the detected event.

This application claims the benefit of U.S. Provisional Patent Application No. 63/277,019, filed 8 Nov. 2021 and U.S. Provisional Patent Application No. 63/281,070, filed 18 Nov. 2021, the entire contents of which are incorporated herein by reference.

### TECHNICAL FIELD

This disclosure generally relates to remote sensing and, more specifically, to techniques for enhancing the information received from remotely placed sensing platforms.

### BACKGROUND

Sensing platforms in remote locations, such as space, the deep ocean or other remote terrestrial locations, often collect much more data than can be transferred to receiver stations over the available communications channels. To compensate, in some example approaches, the remote sensing platform may transmit lower resolution versions of the captured data to ground-based experts, such as a Scientist in the Loop (SITL), who may analyze the data and select subsets of the data for subsequent higher resolution transmission and review. The terms remote sensing and remote sensors are used in this document to refer to sensors that are placed in a location distant (e.g., space) from the people or systems using the collected information (e.g., at a ground station), regardless of the sensor's measurement range.

### SUMMARY

In general, this disclosure describes a decision support tool that assists experts, such as SITLs. The tool detects events in sensor data and automates the collection of data for known events from remote sensing platforms. In one example approach, the decision support tool operates efficiently on sensing platforms in spacecraft and sensor systems such as those deployed in deep space using the Deep Space Network (DSN) to transfer data to Earth, and on other remote sensing platforms, by quantizing samples of telemetry data, to enable highly parallel processing of Quantized Neural Network (QNN) operations. In one example approach, the decision support tool also applies transfer learning and active learning techniques to train effective event detection models that reproduce human data-selection processes using a limited number of examples. Using the decision support tool, scientists supporting space observation missions, such as a future iteration of the Magnetospheric Multiscale (MMS) mission, can identify several examples of target signals, such as magnetic reconnection events near the Earth's magnetopause and magnetotail, which the decision support tool uses to automatically select such events in future data. The decision support tool may be applied on missions to enable the remotely placed sensing systems to use the tool's event detection processes as onboard, learning algorithms and thereby reduce or eliminate the need for human review of known event types.

In a first example approach, the decision support tool includes an AI model trained using events labeled by experts. In a second example approach, the decision support tool includes an AI model trained using historical data that includes events identified by experts. For instance, the historical data may include data described and scored by SITLs over one or more time periods, which may include the input of multiple SITLs both within and across the time periods. In contrast to the first example approach, which trains the QNN model based on objective ground truths, the second example approach trains the model based on a consensus of experts gathered over time.

In one example, a sensor platform includes a memory, the memory storing instructions for generating event detection models used to detect events in captured sensor data; a sensor interface communicatively coupled to the memory, the sensor interface configured to capture data received from sensors connected to the sensor interface and to store the captured sensor data in the memory; and one or more processors communicatively coupled to the memory, the processors configured to execute instructions stored in the memory, the instructions when executed causing the processors to generate and train an event detection model from the instructions; retrieve the captured sensor data from memory; apply the trained event detection model to the captured sensor data, the trained event detection model configured to detect an event from within the captured sensor data; transmit notice of the detected event to a remote observer; and transmit captured sensor data associated with the detected event in response to a request from the remote observer for sensor data corresponding to the detected event.

In another example, a method includes receiving captured sensor data at a remote location; generating and training, at the remote location, an event detection model, the trained event detection model configured to detect an event from within the captured sensor data; applying the trained event detection model at the remote location to the captured sensor data to detect an event from within the captured sensor data; transmitting notice of the detected event to a remote observer; and transmitting captured sensor data associated with the detected event to the remote observer in response to a request from the remote observer for some or all of the sensor data associated with to the detected event.

In yet another example, a non-transitory computer-readable storage medium includes instructions that, when executed, cause one or more processors of a sensor platform to receive captured sensor data; generate and train an event detection model, the trained event detection model configured to detect an event from within the captured sensor data from the instructions; apply the trained event detection model to the captured sensor data to detect an event from within the captured sensor data; transmit notice of the detected event to a remote observer; and transmit captured sensor data associated with the detected event to the remote observer in response to a request from the remote observer for some or all of the sensor data associated with to the detected event.

In yet another example, a sensor system includes a sensor platform; an observer station remote from the sensor platform; and a communications channel connected to the sensor platform and the observer station, wherein the sensor platform includes a memory, the memory storing instructions for generating event detection models used to detect events in the captured sensor data; an interface, the interface configured to receive captured sensor data and store the captured sensor data to memory; and one or more processors communicatively coupled to the memory, the processors configured to execute instructions stored in the memory, the instructions when executed causing the one or more processors to generate and train an event detection model from the instructions; retrieve the captured sensor data from memory; apply the trained event detection model to the captured sensor data, the trained event detection model configured to detect an event from within the captured sensor data; transmit notice of the detected event to a remote observer; and transmit captured sensor data associated with the detected event to the remote observer in response to a request from the remote observer for some or all of the sensor data associated with to the detected event.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1 is a block diagram illustrating a sensor system having a decision support tool that learns from user input to identify events of interest in time-series sensor data, in accordance with the techniques of the disclosure.

FIG. 2 is a block diagram of the example decision support tool of FIG. 1, in accordance with the techniques of the disclosure.

FIG. 3 is a flowchart illustrating operations performed by an example space-based sensor platform, in accordance with the techniques of the disclosure.

FIG. 4 is a flowchart illustrating operations performed by an example user interface for remote operation of a sensing platform, in accordance with the techniques of the disclosure.

FIG. 5 illustrates a space-based sensing platform having a computing platform, in accordance with the techniques of the disclosure.

Like reference characters refer to like elements throughout the figures and description.

### DETAILED DESCRIPTION

Sensing platforms in remote locations often are significantly bandwidth limited in transferring information from the remote sensing platform to a base station. Typically, such sensing platforms collect much more data than can be transferred to receiver stations over the available communications channels. Remote sensing platforms in applications such as, for instance, missions using the Deep Space Network, may only be able to transfer to the ground station a small part of all the data collected by the platform. Data sets for projects on the Deep Space Network are often large, while the bandwidth for transmitting such data sets to ground stations is limited, requiring significant manual effort, such as by SITLs, to select the most relevant information for review and discard the rest. In the following, a decision support tool is described to assist SITLs and to automate in-situ data collection for known events.

In one example approach, the decision support tool operates efficiently at the edge of a collection of remote sensing platforms by enabling highly parallel processing of Quantized Neural Network (QNN) operations. In one such example approach, the decision support tool is also applied to transfer learning and active learning techniques to train effective event detection models that reproduce human data-selection processes via a limited number of examples. In one example approach, the decision support tool is part of a human-AI collaborative pipeline where, for example, scientists supporting a Heliophysics System Observatory (HSO) mission identify examples of target signals for an interesting scientific event and where the decision support tool automatically detects such events in future data.

In one example approach, the remote sensors are memory limited, meaning that the data may only be available for only a limited time, making the timely identification and retrieval of pertinent data that much more important. In the past, remote sensing platforms would, for instance, send lower-information-content selections of the data to the ground station, where experts reviewed the data and determined what higher-information-content sensor data to download from the remote sensing platform. The memory limitations of the remote sensing platform may, in some examples, lead to a race to download relevant information before new sensor data is captured and stored to memory.

For instance, the National Aeronautics and Space Administration (NASA) operates the Magnetospheric Multiscale (MMS) mission, a mission that measures the speed and variability of magnetic field reconnection between the magnetic fields of the Sun and the Earth. Cosmic plasmas are threaded throughout with magnetic field lines of force. The field lines and the plasma are tied to one another and move together with the flow of the plasma. If magnetic fields in adjacent regions have opposite or significantly different orientations, the field lines and plasma may become coupled, with the individual field lines disconnecting from each other and then reconnecting with those in the adjacent region. When this happens, the energy stored in the magnetic fields is released as kinetic energy and heat. The disconnection and reconnection of the plasma and magnetic field lines takes place in a narrow boundary layer called the electron diffusion region (EDR).

Magnetic reconnection is the general term for magnetic field disconnection or connection, either of which may release energy stored in the magnetic fields into the EDR. The MMS mission includes four spacecraft. Each spacecraft includes multiple sensor arrays used when the spacecraft are in a three-dimensional formation, such as a tetrahedron, to measure how the magnetic field of the Sun interacts with the magnetic field of the Earth by observing how the fields connect and disconnect, and by observing the effect of such reconnection on the EDR. In some example approaches, it is critical to determine the time of magnetic reconnection so that the effects of the reconnection may be observed on the EDR sensor data captured at the time of reconnection. The intent is to gather a distribution of magnetospheric conditions at the smallest possible spatial scales and fastest sample rates. This results in a large quantity of data collected at full resolution during each orbit, most of which ends up being overwritten by newer data before it can be downloaded to a ground station.

In the MMS mission, reduced-quality versions of the data are sent to SITL for review and, hopefully, identification of events of interest in the data. SITL may then request higher-quality data associated with events of interest from the remote sensing platform for more in-depth review. In some examples, data collected by the orbiting sensor platform is retained for only a limited amount of time before being replaced with newer data. SITL, therefore, must request the data before it is replaced by new data captured by the sensors of the observatory platform.

The decision support tool described herein may be used to improve data collection, as well as to automate and enhance event detection in other NASA missions, especially in missions involving data collection with limited data access. Applications include Earth-observing, atmospheric, and magnetospheric survey missions, such as MMS, WIND, THEMIS, Cluster II, STEREO, and the Europa Lander. The decision support tool also has application in commercial and government Geographic Information Systems (GIS). Long-running surveillance operations, including law enforcement, energy, and utility monitoring, as well as security systems, may also employ the decision support tool to reduce manual effort and to quickly identify time-critical events at the point of occurrence to improve incident response time.

In one example approach, the decision support tool assists SITLs in detecting events. In some such example approaches, the decision support tool also automates in-situ data collection for known events. In one example approach, the decision support tool operates efficiently at the extreme edge by enabling highly parallel processing of Quantized Neural Network (QNN) operations on the sensor platform. In some example approaches, transfer learning and active learning techniques are used to train effective event detection models that reproduce human data-selection processes using a limited number of examples. The decision support tool may therefore be used to provide a human-AI collaborative pipeline where, for example, scientists supporting a Heliophysics System Observatory (HSO) mission may identify examples of target signals for an interesting scientific event, which the decision support tool uses to automatically select such events in future data.

NASA science and engineering increasingly are adopting the use of artificial intelligence (AI) technologies to support the processing and use of remote sensor data. The quantity, complexity, and goals of space science datasets are expanding, such that many ongoing and planned missions may benefit from additional support to effectively develop and use AI technologies for a broad range of data types and learning objectives. In many cases, only a fraction of remotely collected data is actually analyzed and used for scientific discovery.

Machine learning and deep learning methods are employed today to assist scientists with data analysis, such as the Ground Loop System (GLS) Magnetopause (MP) model used by SITLs for the MMS mission. However, usefulness of such models is limited by only having access to reduced-quality data for finding potential new events of interest, and a short time period to process new data. As a result, SITLs only use current models for guidance along with Automated Burst System (ABS) recommendations, and still spend hours per week selecting data, including providing manual review of well-established, known event types.

AI technologies may be used to identify important information at the point of collection, which provides access to full-quality data. However, such an approach may require operating in spite of constrained computing capabilities, specialized hardware, and limited interaction with end users. Despite these constraints, low-overhead AI tools at the point of data collection may be helpful in identifying important information as it is detected and reducing burden on storage, network and human resources.

In some example approaches, however, where communications bandwidth limits the quality and quantity of data transferred from a remote sensing or distant in-situ sensing platform and processing at the point of data collection is difficult due to constrained computing capabilities or the presence of specialized hardware in the remote sensing platform, a combined approach of processing at the remote sensor platform and further processing at the end user location may, at times, be more effective. Technologies that take advantage of increased data availability at the point of collection along with the increased computing capability and expert guidance at the end user location may, in such situations, open up opportunities for new paradigms of scientific discovery with collaborative AI tools.

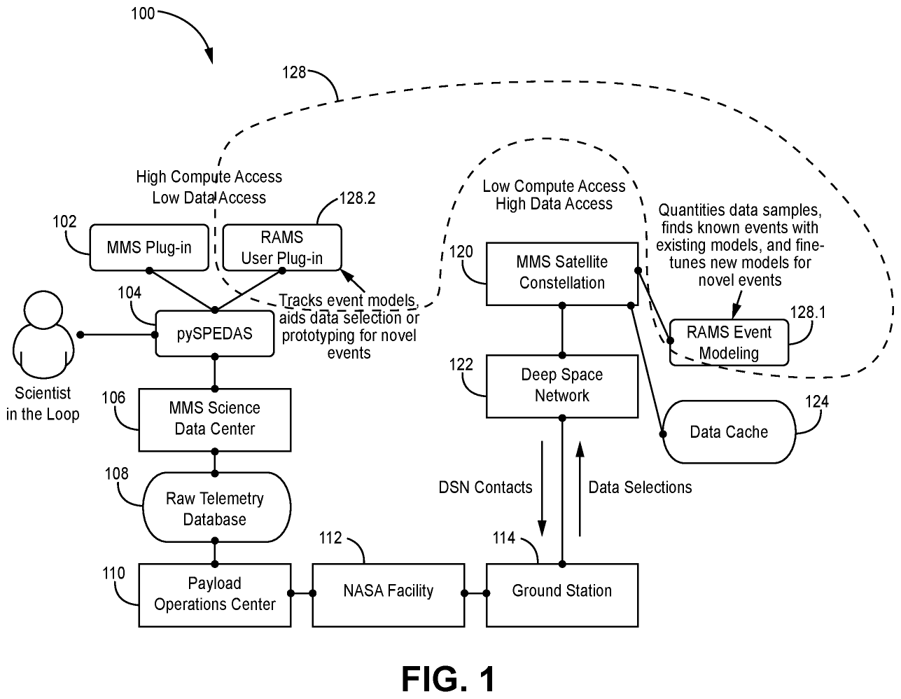

FIG. 1 is a block diagram illustrating a sensor system having a decision support tool 128 that learns from user input to identify events of interest in time-series sensor data, in accordance with the techniques of the disclosure. In one example approach, decision support tool 128 samples and quantizes data streams to train and apply reduced-precision models, e.g., Quantized Neural Networks (QNNs), efficiently on constrained computing platforms such as spacecraft and sensor systems. As illustrated in FIG. 1, sensor system 100 includes a constellation of MMS satellites 120 connected through the Deep Space Network 122 to an observer station 110 such as the Payload Operations Center.

As shown in FIG. 1, the decision support tool 128 includes two components, Event Modeling 128.1 and User Plug-in 128.2, which integrate with existing data processing workflows for remote sensing or at-the-edge sensing applications. Although the example shown in FIG. 1 is a tool provided for an MMS-like mission, tool 128 may also be used for other unmanned applications, such as rovers, landers, small satellites, and any survey mission that involves analyzing significant quantities of data collected from remote locations. In one such example approach, Event Modeling 128.1 quantizes data samples, finds known events with existing models, and fine-tunes new models for novel events, while User Plug-In 128.2 tracks event models and aids data selection and prototyping on the part of SITL for novel events.

In the example shown in FIG. 1, MMS satellites 120 capture sensor data corresponding to how the magnetic fields of Earth and the Sun connect and disconnect, and the effect of that connection and disconnection on an EDR. The captured data is stored; portions of the stored data are then transmitted to ground station 114 by a network 122, such as the Deep Space Network. In some examples, such as is shown in FIG. 1, the data is stored in a data cache 124 connected to satellites 120. The data in data cache 124 is present for a limited time; it is written over with new data after a short period of time.

In one example approach, satellites 120 transfer notices of events detected by Event Modeling 128.1 to ground station 114 via network 122. Satellites 120 also transfer both reduced quality and science quality versions of the captured data stored in data cache 124 to ground station 114 via network 122. Typically, the reduced quality data is transferred to a NASA facility 112 and stored in a raw telemetry database 108 in observer station 110. In one example approach, scientists operating in the MMS data center 106 use software tools such as MMS Plug-In 102 and the Python version of the Space Physics Environment Data Analysis Software (pySPEDAS) 104 to review the reduced quality data and to select higher quality data to be downloaded from data cache 124 for further review. Space Physics Environment Data Analysis Software, or SPEDAS, is an established software framework, which supports over 20 scientific missions across NASA, NOAA, EPA, etc. The pySPEDAS version may be implemented in Python, which facilitates integration with popular ML libraries, such as PyTorch, TensorFlow, and MXNet, as they all maintain Python APIs. User data selections 132 made by SITL are returned to DSN 122 and used to download the requested higher resolution data from data cache 124.

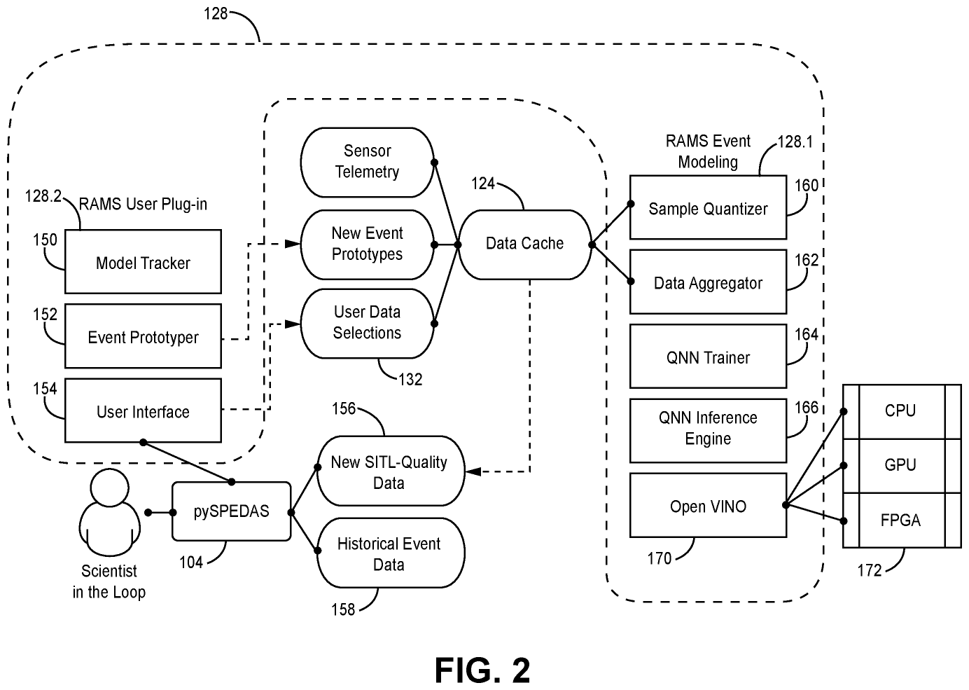

FIG. 2 is a block diagram of the example AI decision support tool of FIG. 1, in accordance with the techniques of the disclosure. The decision support tool learns from user input to identify events of interest in remote sensor data. In one example, tool 128 samples and quantizes data streams to train and apply reduced-precision models, e.g., Quantized Neural Networks (QNNs), efficiently on constrained computing platforms such as remote systems using the Deep Space Network.

In the example shown in FIG. 2, Event Modeling 128.1 includes four main components: a sample quantizer 160, a data aggregator 162, a QNN trainer 164 and a QNN inference engine 166. In one example approach, sample quantizer 160 samples and quantizes the sensor data streams, fine-tunes event classifiers for new event classes, and analyzes quantized data to identify events of interest. Pre-trained QNN models are maintained for each remote sensing application.

Data aggregator 162 aggregates the data retrieved when SITL requests higher quality data corresponding to an event. QNN trainer 164 trains the QNN models and refines the existing QNN models with data intervals representing examples of an interesting event class to produce event classifiers in QNN inference engine 166. In a first example approach, QNN trainer 164 maintains and updates data selection models using events labeled by experts within data as it is collected, and QNN inference engine 166 applies the latest trained models to select new instances of these events as data continues to be collected, eventually being deemed reliable enough by experts to automate detection of those event types. In a second example approach, QNN trainer 164 trains data selection models using historical data that includes events identified by experts. For instance, the historical data may include data described and scored by SITLs over one or more time periods, which may include the input of multiple SITLs both within and across the time periods. Elements of both the first and second example approaches may be combined, such as training initial data selection models using historical data and then refining models with newer labeled examples, which may reflect improved scientific understanding by experts. Given the nature of scientific discovery, expert event labels, such as data selections and scoring by SITLs, is subject to greater variation over time and between experts than most other data classification tasks, such as object recognition in images. Thus, the QNN models are considered to be learning a consensus of experts gathered over time, rather than absolute or unchanging ground truth labels. Tests indicate that the second example approach is effective for training models that can be used by QNN Inference Engine 166 to accurately reproduce selections in test data corresponding to the consensus of available expert selections in historical data. Significant inconsistencies were observed in the labelling of selected events in the historical data, depending on which SITL was on duty, and due to changes in mission parameters over time. Word clouds confirm, for instance, that term frequencies in SITL labeling are significantly different for certain months. Furthermore, there are no established methods for determining which expert label is “correct” or “best,” so it is difficult to pre-weight the data. Despite these considerations, QNN models were successfully trained to select within held-out test datasets the most agreed-upon types of data representations among experts over time within historical data.

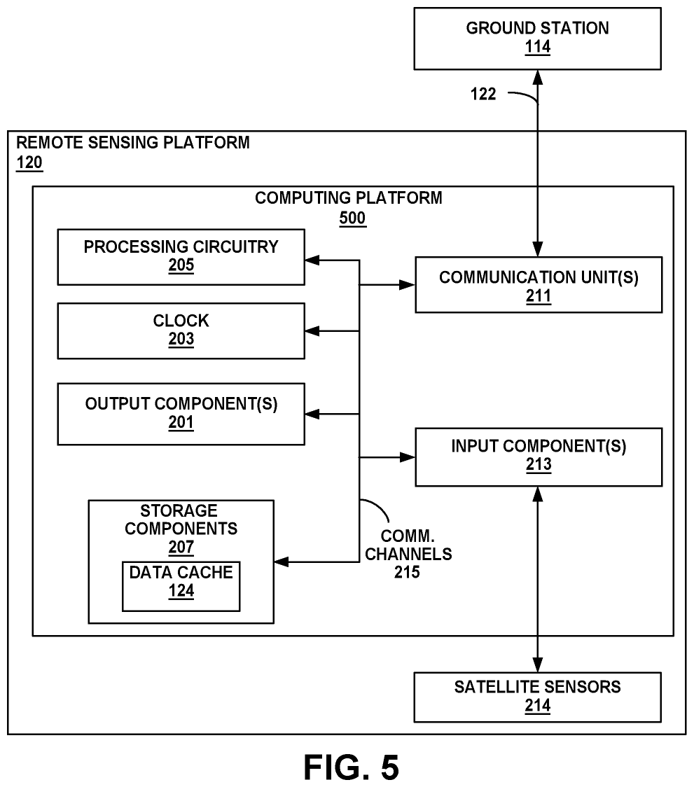

In one such example approach, an open-source ML library for heterogenous hardware optimization and execution, such as the OpenVINO toolkit 170, enables tool 128 to effectively utilize any available computing resources (such as processing circuitry 205 in FIG. 5) on remote sensing or space sensing platforms such as CubeSats or other small satellites. Similar structures may be used to add event sensing capability to other remotely placed sensor platforms, such as, for example, deep ocean platforms.

As shown in the example in FIG. 2, in one example approach, User Plug-in 128.2 integrates with the open-source SPEDAS tool 104 for scientific data analysis. User Plug-in 128.2 includes Model Tracker 150, Event Prototyper 152, and User Interface 154 components, which provide users with the ability to observe data selections made by event models and to identify examples of additional events. In one example approach, users may interact with user interface 154 to provide feedback on model predictions, which Model Tracker 150 uses to introduce refinements in the affected models. User interface 154 may also, in some example approaches, be used to select data 156 to be retrieved that is associated with identified events, or to retrieve historical data 158 for use in prototyping new models. User data selections 132 made by SITL are returned to DSN 122 and used to download the requested higher resolution data from data cache 124. Model Tracker 150 may also, in some example approaches, be used to compute community-wide performance ratings for each event model, so users know the overall confidence level associated with event detections and how models improve over time.

In one example approach, when a user observes a new type of interesting event in the latest data, the relevant time intervals are labeled as an example of this event, and the remote Event Modeling application uses the associated cached data to begin fine-tuning a new detection model. Note that this process enables the user to work with familiar SITL-quality data 156 and interpretable features, while also allowing models to use any features of the full, science-quality data to achieve the best detection performance for a given event.

Event Prototyper 152 provides the ability to study and model previously collected sensor data using local computing resources; it can be used to test prototype detection models for unidentified readings or event sub-types. This enables making use of time between data selection periods, as well as greater computing capabilities and historical information to improve automated event detection. Event Prototyper 152 is also able to predict performance of models on target platforms, such as satellites and other spacecraft. In some example approaches, tool 128 also provide predefined training routines to reduce user effort.

In one example approach, decision support tool 128 enables automated event detection onboard space-based sensing platforms. Automated event detection reduces the human effort required for routine sensor data analysis while achieving more comprehensive and continuous review of raw telemetry feeds. In one such example approach, tool 128 takes advantage of SITL review to provide active learning signals to efficiently train new event detection models using existing models, via transfer learning methods. The user interface and software tools are designed to integrate with existing SITL workflows, such as by providing a User Plug-in 128.2 for the SPEDAS scientific analysis platform. Decision support tool 128 therefore allows scientists to concentrate on discovering new phenomena while harnessing remote sensing platforms to automate detection of known events.

Furthermore, the event modeling processes sample and quantize sensor data to facilitate highly parallel, rapid training and detection operations on remote sensing platforms. In one example approach, Event Modeling 128.1 uses open-source libraries for accelerating machine learning on specialized hardware, such as FPGA, GPU, and emerging AI-optimized chipsets, which significantly reduces power consumption. Together, these features enable Event Modeling 128.1 to continuously detect relevant events using streams of sensor data processed on constrained computing systems, such as operating onboard spacecraft. This reduces the burden on scientists to continually review survey data and select interesting data, freeing them up to focus on scientific discovery.

Event detection models based on remote sensor data typically are developed as part of Ground Loop Systems at Science Data Centers. These use-cases provide only limited SITL-quality information and require rapid prediction of events within long periods of data given only short processing timeframes. This has resulted in models that may help guide SITL experts during routine selection of sensor data, such as the MP boundary-crossing event detector for the MMS mission, but model accuracy is limited (roughly 75% for the MP model) and experts still spend hours each week identifying routine events.

In contrast, the modeling technology of Event Modeling 128.1 innovates on current event detection modeling practices by incorporating signal sampling, quantization, and modeling of time-series data using Long Short-Term Memory (LSTM) networks implemented as Quantized Neural Networks (QNNs). Further, active learning and transfer learning principles are employed to enable efficient training of event classifiers for multiple event types of interest using only a limited number of examples. Finally, as noted above, Event Modeling 128.1 uses one or more open-source libraries for optimization and execution of ML algorithms on heterogenous computing platforms, such as OpenVINO 170, to enable training and using event classifiers with constrained and specialized computing systems 172, such as on remote sensing platforms.

In one example approach, sampling methods based on the preprocessing steps used to generate SITL-quality data are used to compute features for a magnetopause (MP) model. In one example approach, the MP model uses 123 features as inputs. The features include standard instrument products and meta-features derived from those readings; these features have been found to be useful in related studies such as in Argall Matthew R., et al. “MMS SITL Ground Loop: Automating the Burst Data Selection Process”, Frontiers in Astronomy and Space Sciences, Vol. 7, September 2020: https://www.frontiersin.org/articles/10.3389/fspas.2020.00054/full, the description of which is incorporated herein by reference.

In one example approach, each input datapoint was composed of the above-identified features computed for 4.5-second intervals, with consecutive datapoints being processed sequentially by the LSTM model. Sequences of 250 consecutive datapoints were used as training examples. Feature values were scaled and normalized based on the average and standard deviation of values observed. The SITL-selected time intervals over a one-month period were used as the training and test dataset. In one such example approach, only data from the MMS1 spacecraft was used for the MP model.

In one example approach, the model is selected to efficiently model raw telemetry data, minimizing preprocessing steps used such as preliminary calibration and avoiding the use of meta-features. Varying sample intervals were tested to enable models to learn features with finer and coarser temporal resolutions. In one example approach, the data from one spacecraft was processed at a time, due to concerns with the effects of timing and of orbital configuration. Further, data from different spacecraft may not be available when operating onboard a sensor platform. In one example approach, data from multiple MMS spacecraft is analyzed, separately, as available in the publicly available datasets for common time periods.

In one example approach, samples are quantized using selected bit-level representations, such as 32-bit (floating point), 16-bit, 8-bit, and 1-bit (binary) precision levels, or representations using the TensorFlow Brain Float 16-bit, or bfloat16, format. Unlike IEEE 754 half-precision or 16-bit integer formats, bfloat16 avoids the need for block quantization steps or special hyperparameter tuning during model training. Different rounding strategies may be selected to quantize sample values in terms of the minimum and maximum ranges of the associated sensor output or observed background levels.

A QNN design may be configured to quantize input values as part of the neural network node operations, replacing the conventional activation function, like a sigmoid operator, with a quantization function, such as a step function for one-bit quantization. For QNNs processing sequential samples of time-series data, this approach is effectively a form of Pulse-Code Modulation (PCM). Namely, the signal amplitude of each node's output activation is encoded as an approximate digital value with the associated bit-level resolution.

For relatively high sample-rates, such as those collected by the MMS Fast Plasma Investigation (FPI) spectrometers, Pulse-Density Modulation (PDM) may be selected to provide an effective alternative digital representation to model signals of useful events. For instance, sensor readings at 30 ms and 150 ms intervals may be used to produce features based on one-bit delta-sigma modulated signal encoding. This is approximately a 30 to 150-times oversampled signal relative to the 4.5-second intervals used to detect MP crossing events, which is comparable to the 64-times oversampling used to reduce noise in one-bit PDM encoding of the Super Audio format.

Technical risks associated with developing models to effectively preprocess data at the sensor platform include that insufficient preprocessing, lack of meta-features, or excessive loss of precision may prevent effective use of quantized sensor samples as effective model features in subsequent tasks. In one example approach, these risks are mitigated by generating ranges of samples with varying degrees of each potentially problematic data-processing step, so that a useful feature representation is more likely to be found.

Designing the QNN modeling process for event recognition will be discussed next in the context of MP crossing and Dipolarization Front (DF) events. In one example approach, LSTM-based QNN model structures are used to classify scientifically relevant events in sensor data. In one such example approach, an open-source BMXNet quantized neural network library, an extension of the Apache MXNet deep learning library, is used to train QNN models for event classification.

In one example approach, QNN models for classifying Magnetopause (MP) crossing and Dipolarization Front (DF) events are developed based on quantized sensor data. In one such example approach, the structure of the QNN models is adapted from a bidirectional LSTM network used for MP crossing detection. That model is designed to use features based on SITL-quality data, such as that available to scientists on the ground. In one example approach, the input features and associated input layers of the QNN may be adjusted to use quantized, preprocessed samples of burst data, which is like what would be available while operating on the space-based sensor platforms.

The approach described above may be adapted to other sensor platforms. In one example approach, users select between model structures, hyperparameter settings, and regularization strategies and observe the effects on learning efficiency and performance in predicting types of events. In the current MMS example, different sample time intervals or a selection of PDM-based versus PCM-based features may be useful in predicting MP crossing versus DF events. Ablation studies may be used to assess the importance and role of features of each type of event and the level of quantization needed to predict different types of events. Meanwhile, greater temporal resolution may be helpful to model some events, while greater signal amplitude resolution is beneficial to detect other events.

In one example approach, QNN event classifiers are trained at different precision levels to determine the most effective precision level to use. During previous work with quantized Convolutional Neural Network (CNN) models used for image classification, peak model accuracy during training turned out to be especially sensitive to the precision level of error gradients used during the back-propagation step. If this is also the case for classifying events in sensor data received from a space-based sensor platform, training methods should be designed accordingly. For example, asymmetrical precision levels in the forward and backward propagation of inference and error gradient signals, respectively, may be implemented. This enables using more processing power to precisely tune model parameters during training, while requiring less processing power to make predictions with the trained event classifiers.

In some example approaches, transfer learning methods may be used to enhance the efficiency of training event detection models. The goal is to provide starting parameters for a new event detection model that facilitate faster convergence to high detection accuracy with fewer training examples of the new event class, as compared to randomly initialized parameters. In one such example approach, self-supervised learning objectives are used to pre-train a QNN model, such as by predicting the input examples that have had certain types of noise purposely introduced to the sensor data. This approach enables using all available data with sufficient quality flags for pre-training, not just SITL-labeled examples. In another approach, a QNN model trained to detect one type of event, such as an MP crossing detector, is used as a pre-trained starting point for learning to detect a different type of event, such as DF events. In both cases, one should measure the rate of increase in test accuracy and the highest attained test accuracy while fine-tuning the pre-trained models and compare their performance to starting with randomly initialized parameters.

Active learning techniques may also be used to increase the efficiency of QNN model training. The training efficiency for each active learning approach may be used to select between the approaches, such as number of labeled examples required to attain a target prediction accuracy on the test dataset, and the results compared to techniques such as using comprehensive labels that are unguided by the model. The efficacy of each active learning technique may be tested by simulating active learning using selected examples of SITL-labeled events and non-events as the training examples that the interactive process would have recommended for learning during historical periods of MMS operation. In one such approach, sample selection strategies such as the Active Thompson Sampling (ATS) and Mismatch-First Farthest-Traversal (MFFT) algorithms may be used to choose which examples to label. One may then measure the training efficiency. MFFT, for instance, has been reported as an effective selection method for active learning of sound event detection with recurrent neural network models. One may then measure the training efficiency for each active learning approach, such as number of labeled examples required to attain a target prediction accuracy on the test dataset and compare them to using comprehensive labels that are unguided by the model.

One should be careful when designing the LSTM models. LSTM models tend to overfit, and it can be difficult to attain high prediction accuracy for events in held-out test datasets. These risks can be mitigated via regularization techniques that have been shown to be effective in modeling data sequences, combined with using different network structures and input features to facilitate finding a process that leads to generalizable predictions.

In one example approach, instead of predicting the type of event that may be occurring within a given interval of sensor data, a Figure of Merit (FOM) or other scoring type metric is calculated and used to prioritize data to be downloaded within the given interval. That is, Event Modeling 128.1 trains a model designed to predict the priority or importance of the data. FOM may be used, for instance, to select intervals of sensor data that are retained at higher resolution for scientific study. In one example approach, neural network-based models are used to predict the Figure of Merit (FOM) categories that would be assigned to selected time periods of MMS data by SITLs; data at the point of collection may, therefore, be prioritized for selection based on the FOM.

Network model architectures other than LSTM may be used, including U-Net, feed-forward, and a 1-dimensional time-series CNN. Bidirectional LSTM and U-Net architectures, however, resulted in the highest prediction accuracies for MP detection and FOM prediction. The U-Net structure enables model simplification and quantization for running efficiently and continuously selecting data on embedded and ASIC computing devices.

In a study comparing data selections made by different SITL experts on MMS data throughout a two-year period spanning 2017 and 2018 of MMS data, significant variations were found in the descriptions used for selected time periods across different months and between users, such as the terminology used by different SITLs to identify each type of MP crossing event. The distributions of FOM scores assigned to selected time periods over that period varied significantly between SITLs, even within the selections for MP events. On the other hand, MP detection models trained with different SITL selections as labels yielded measurably different selection results. The effect of the random training and test data splitting process, however, also showed a potentially significant impact on the resulting selection accuracy for held-out test examples. Thus, further study is needed to understand the role of differences in expert data selection processes on developing a rational agent representing these processes.

In one example approach, the results of the existing MP model were reproduced with TensorFlow version 2 of the Python TensorFlow library. The MP model was trained on a standard desktop computer using a CPU processor; model performance and latency times were recorded. In one such example approach, the model architecture, training process and dataset used were based on the description in Argall Matthew R., et al. “MMS SITL Ground Loop: Automating the Burst Data Selection Process”, Frontiers in Astronomy and Space Sciences, Vol. 7, September 2020: https://www.frontiersin.org/articles/10.3389/fspas.2020.00054/full, the description of which is incorporated herein by reference.

In one example approach, the neural network model used is a bidirectional Long Short-Term Memory (bi-LSTM) neural network with two hidden layers of sigmoid-activation nodes. The model outputs a predicted likelihood that the input features represent MMS spacecraft sensor readings collected while it is crossing the Earth's magnetopause. The training data comprise features computed using about one month of Scientist-in-the-Loop quality-level (SITL-level) sensor data collected by the MMS1 spacecraft during January 2017. The features were computed by resampling the sensor data to represent sequential 4.5-second time intervals. Each set of features for this time interval served as an input example that could be provided to the event detection model to generate a prediction about whether it was collected during an MP crossing. All the examples in the training dataset were labeled with Boolean values describing whether the attending SITL actually described that time interval as being part of an MP event.

The model training process used was based on a commonly used supervised learning procedure, which involves up to 300 iterations, or epochs. In each epoch, batches of examples were used to compute the model's error in predicting labels given the corresponding input examples, then the loss and computing error gradients were backpropagated to update the model parameters in an attempt to increase subsequent prediction accuracy. A subset of the labeled examples was set aside as validation data, which was used to assess how well the current model predictions generalize to examples that are not part of the training data. The parameters that yielded the highest prediction accuracy for validation data were retained as the trained model configuration.

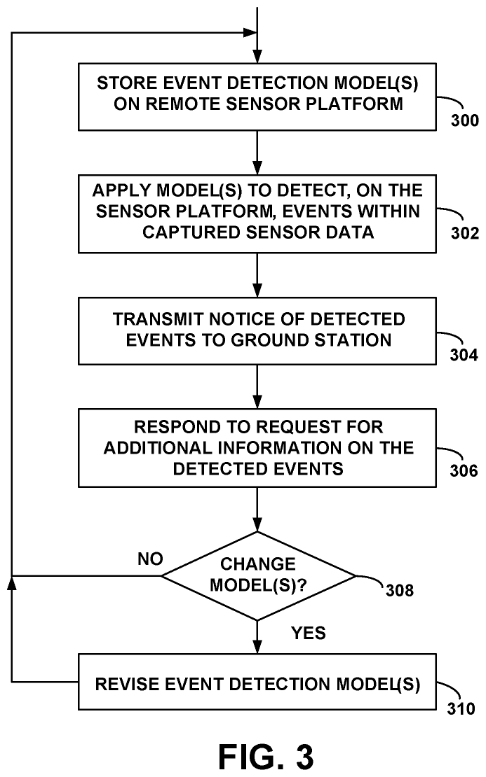

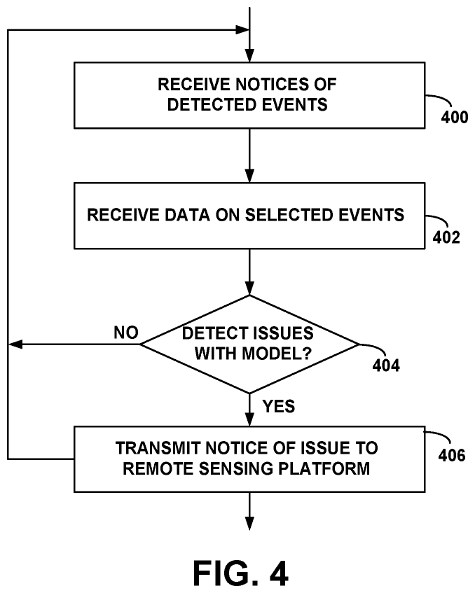

As noted above, in some example approaches, the feature set described, for instance, by Argall Matthew R., et al. includes 123 features, which is a large burden on the sensor platform. In some example approaches, therefore, the feature set is reduced in size by ranking the 123 features of the model using a correlation-based method for time-series data. This method involves training a KNN (k-nearest neighbor) classifier for each feature separately and then using correlations of model output between pairs of features as well as between each feature output and the ground truth outputs to compute merit scores for groups of features subsets. Merit scores were calculated sequentially for groups of 4 features at a time, due to the computational constraints of computing merit scores for groups of features of larger sizes. All of the 123 features were ranked in groups of 4 in order of importance. Three models were then trained with 123 features, 24 top features, and 12 top features respectively, for 300 epochs each. e measured differences in model performance based on the F1-score (FIG. 3), measured differences in model size (FIG. 4), and measured differences in average inferences times (FIG. 5) for time series inputs of 250 time points. The F1-score performance metric provides an aggregate measure of the ratio between True Positive (TP), False Positive (FP), and False Negative (FN) detection rates:

$${F}_{1} = 2 \cdot \frac{TP}{TP + \frac{1}{2} ( FP + FN )}$$

A significant reduction in the number of input features used resulted in only a relatively small reduction in model performance. Even when using only a tenth of the features (12 vs. 123), the 12-feature model reached an F1 score of −0.61 vs a score of −0.67 for the model based on the entire feature set. Although reducing the number of input features does not significantly reduce the model size, it does reduce the size of the input data, eliminating the need for extracting and calculating many of the features, without which the model still achieves an acceptable level of performance.

In one example approach, the models trained in the TensorFlow Library were converted to compressed versions that were meant to be used with mobile or “Edge” devices. A TensorFlow Lite Optimizing Converter (TOCO) was used to take a trained TensorFlow model as input and outputs a TFLite (.tflite) file. TFLite models were saved in FlatBuffer-based files, containing a reduced, binary representation of the original model. FlatBuffers play an important role in serializing model data and providing quick access to that data while maintaining a small binary size. This is particularly useful for models that are heavily populated with numerical weight data that can create a lot of latency in read operations. In the present case, there was a negligible drop in model performance when converting from a standard TensorFlow model to TFLite version but there was a significant reduction in model size and a slight increase in inference latency. The increased latency may, however, be due to the fact that the models were tested on a standard Intel-based processor rather than an ARM processor, which is more typically used for “edge computing” applications, and for which they are optimized. The inference latency should be significantly lower for a TFLite model on an ARM processor compared to a standard TensorFlow model.

In another example approach, the models were based on a U-Net model architecture, which was found to run substantially faster on a target Edge Tensor Processor Unit (TPU) device, such as the Edge TPU devices provided by Google Inc. An Edge TPU is an application-specific integrated circuit (ASIC) used to accelerate machine learning workloads and deliver high performance in a small physical and power footprint, enabling the deployment of high-accuracy AI at the edge. Edge TPUs are compatible with models developed with or converted to TensorFlow Lite, which is the neural network development library described above. In one such example approach, compatible neural network models were run on an Edge TPU device attached to a Raspberry Pi.

In one example approach, Event Modeling 128.1 includes a CPU and an Edge TPU. In one such example approach, compatible neural network models were run on an Edge TPU device attached to a Raspberry Pi. In some such example approaches, inference engine 166 executes RNN-based models, such as the time-series MP-crossing model. In other such example approaches, inference engine 166 predicts events via the Edge TPU based on time series using a different model architecture that does not involve recurrent connections and instead makes use of convolutional operations supported on the Edge TPU.

As noted above, in one example approach, inference engine 166 uses a U-Net neural network architecture. U-NET was first introduced in the image-processing domain for semantic segmentation tasks but has since then also been used for processing time series. U-NET is a type of convolutional neural network (CNN) rather a recurrent one. A 1-dimensional convolutional operation is a known alternative to recurrent operations for temporal data. It is particularly useful for extracting features from data that contains short temporal dependencies. In terms of inference speed, convolutional neural networks have an advantage in that they process time series inputs in parallel rather than sequentially as compared to recurrent models.

All neural network architectures are relatively modular and have various aspects that can be adjusted as simple “hyperparameter” changes, such as the number of layers in the model, the number of hidden units, the learning rate, etc. These changes often involve a tradeoff in aspects such as model size, model performance and training time. In one such example approach, tests are performed to determine an optimal U-NET model architecture having both high performance and low size.

In one such example approach, tests were performed on both standard and TFLite versions of the U-NET model on a standard Intel CPU as well as an Edge TPU; the tests recorded model sizes, F1 scores, and inference times. In tests on models using only 12 features, the U-Net model is smaller in size relative to the 12-feature bi-LSTM model, for both the standard and TFLite versions, while having a significantly faster inference speed and higher accuracy (F1-score). Converting the U-NET to an 8-bit TFLite version further reduced model size and increased inference speed, while maintaining a high level of accuracy.

For instance, the F1-score for a 12-feature U-NET model is higher than for a 12-feature bi-LSTM model both for the standard TensorFlow and TFLite versions. In fact, the F1-score for the 12-feature U-NET is comparable to the F1-score for the 123-feature bi-LSTM. At the same time, the size of the 12-feature U-NET model is smaller than the size of the 12-feature bi-LSTM model for both the standard and lite versions. Finally, the inference speed of all 12-feature U-NET models is faster than the inference speed of all 12-feature bi-LSTM models. This is true even when comparing the TFLite version of the bi-LSTM model to the standard TensorFlow version of the U-NET model. The inference speed of the TFLite U-NET version, however, was faster on a standard Intel CPU than on the Edge TPU. This may be due to the fact that the Edge TPU was optimized for specific model sizes and numbers of parameters and that there are limitations in data transfer rates between the Edge TPU and the Raspberry Pi on the test platform. However, even if the Edge TPU does not improve inference speed in all cases, it still allows for very short inference runtimes and has advantages in compactness and potentially reduced power consumption.

FIG. 3 is a flowchart illustrating operations performed by an example space-based sensor platform, in accordance with the techniques of the disclosure. In the example shown in FIG. 3, an event detection model is stored on a sensor platform, such as satellite constellation 120 shown in FIGS. 1 and 2 (300). The model is applied in Event Modeling 128.1 to detect events within the captured sensor data (302). Notices of the events detected are transmitted by the satellites of constellation 120 via network 122 to ground station 114 (304). A user on the ground reviews the notices and requests additional information on selected events from the list of detected events, which are then delivered by the satellites of constellation 120 via network 122 (306). A check is made to determine if any changes should be made to the model (308). If changes are not needed, control returns to 300.

If, however, changes are needed to the model, the model is revised before control returns to 300. In some example approaches, a user such as SITL may detect false positives in the events detected and notify the model of the false positives. The model then is redone with each false positive event marked as negative.

As seen in FIG. 3, Event Modeling 128.1 continuously analyzes data collected onboard a sensor platform and selects scientifically useful portions of the data to be transferred to consumers of the data, located elsewhere. As designed, Event Modeling 128.1 is capable of performing an inference operation with the data selection model, such as the TFLite model described above, and generating output predictions for all 248 datapoints of 4.5-second samples in the current time sequence. Further, Event Modeling 128.1 is capable of applying a threshold to the prediction values to convert the 8-bit or 32-bit precision activation values into Boolean values indicating whether or not the data would be selected as an interesting event, such as an MP crossing event. Model accuracy can be assessed using expert-labeled data, for example by comparing model predictions to the SITL labels for a previously collected time sequence to compute accuracy or true positive and true negative metrics, and displaying the results for the selection process within that time sequence. In practice, lower detection thresholds result in more conservative predictions, with fewer missed events (false negatives) but more false alarms (false positives). Higher detection thresholds result in fewer event detections and false alarms, but more missed events. In one example approach, a threshold was chosen to provide equal error rates (EER) for false positives and negatives (that is, equal false negative and false positive error rates).

Event Modeling 128.1 has, therefore, been shown to be capable of continuously processing all data collected on a remote sensor platform in real-time, despite constrained computing resources and limited expert feedback.

The model described above matched the published MP detection model F1 score of approximately 0.67. It is believed that some of the deviation of the model's accuracy from a perfect score of 1.0 is due to the goal of predicting somewhat subjective labels provided by multiple different experts. Such labels could potentially contain contradictory or mutually exclusive selection patterns, which would preclude learning a function that perfectly correlates input features to all labels. One way to narrow the possible extent of loss that can be attributed to the subjective-label and multiple-labeler problems is to attempt to increase prediction accuracy of the models as much as possible.

In one example approach, the time periods of data available for training and testing data selection models are expanded. In one such example approach, this entailed downloading the Common Data Format (CDF) binary files containing the L2-quality survey data for the MMS1 spacecraft's DIS, DES, AFG, and EDP sensor systems within a specified time range. The four datasets were then merged by resampling the lower frequency data sources to have values for each of the 4.5-second samples of the DES survey data. 129 input features were then obtained from the merged survey data. The SITL selections for the specified time range were also downloaded via the PyMMS API, and the selections were used to label the associated time periods of the feature dataset with the SITL source ID, FOM score, discussion text, and whether the data sample was described as an MP or CS event.

A dataset of these time sequences of labeled feature vectors was compiled for all available MMS1 survey and SITL selection data in the years 2017 and 2018. There was no data available for the latter half of February, as well as April and May of 2017, because the MMS spacecraft underwent an orbital change maneuver during this time, so the sensors were deactivated to avoid damaging them. In addition, some time periods used different energy band ranges for the 32 directional ion and electron spectrogram features. Furthermore, some time periods during November and December of 2017 and 2018 had atypical energy band ranges, so those time periods were excluded from the dataset to ensure the spectrogram features represent consistent measurements throughout the training and test examples.

As expected, increasing the amount of training data tends to increase the prediction accuracy and generalizability of the event detector. This makes sense, because the model will likely be exposed to a wider variety of feature-label combinations when trained with more examples that introduce the possibility for representing a more diverse set of conditions.

It is interesting that the 2017 dataset enabled higher prediction accuracies than the 2018 dataset for both the UNET and bi-LSTM model types. One possible reason for this is that the 2017 dataset contains about 11% more SITL selection records than the 2018 dataset, so the diversity and learnable generalizations represented in the 2017 dataset may be greater than those in the 2018 dataset.

Receiver Operating Characteristic (ROC) curves were visualized for these models to assess whether expanding the dataset showed any effect on the sensitivity of the UNET or bi-LSTM models. The ROC curves reveal that the models do exhibit different sensitivities with respect to detection threshold; the dataset used appears to play a role in the shape of the curve. As examples, the UNET and bi-LSTM models trained with the same January 2017 dataset both display similarly sharply increasing ROC curves near zero FPR, whereas none of the UNET and bi-LSTM models trained by data outside that test period showed that behavior.

Finally, 24-input-feature and 12-input-feature UNET MP detection models were trained using the largest available dataset (the 2017 and 2018 SITL-annotated dataset). A comparison of prediction accuracies for the 129-input-feature UNET model to a 24-feature model and a 12-feature model developed as in the bi-LSTM model above showed that reducing the number of features from 129 to 24 led to only a 0.02-point drop in F1 score (from 0.79 to 0.77), while reducing the number of features from 129 to 12 led to only a 0.05-point drop in F1 score (from 0.79 to 0.74). Using fewer than 10% of the input features resulted in about 5% lower F1 score. This result is comparable to the F1 score reduction of about 6% observed between the 123-feature and 12-feature bi-LSTM MP detection models described previously, which were trained using the January 2017 SITL-quality dataset. This finding confirms that the accuracy observed for a 12-feature model is due to a slight loss in accuracy caused by removing over 90% of the input features and not some kind of hard ceiling related to the reduced representational capacity of the smaller model.

In some example approaches, models are trained to predict additional types of events, such as magnetic reconnection or Kelvin-Helmholtz (KH) instability phenomena. Rare events provide an opportunity to test transfer learning techniques and determine whether event detection models trained to classify more frequent event types can be fine-tuned using a limited number of examples to detect other, less common event types. Transfer learning has been shown in other applications, such as image processing, to significantly reduce the number of training examples required to develop effective classifiers. For example, transfer learning methods may be used to assess the effectiveness of fine-tuning and retraining an MP detector to identify KH events.

In some example approaches, self-supervised learning strategies are used as part of the model training process, particularly for rarer event types. Self-supervised learning involves generating additional labeled data examples by applying known permutations to existing datasets. Examples with self-generated labels may be used to augment or kick-start a model's learning process, potentially reducing the need for actual labeled training examples.

The most common challenge with using self-supervised learning is selecting or formulating a permutation that is sufficiently representative of the actual learning objective to lead to model features that are useful, or at least benefit the overall training process. Different permutation-label pairs may be useful, such as generating a dataset with certain noise or stimuli applied to the electric, magnetic, or ionic features and then pretraining event detectors to predict the presence of a modification.

FIG. 4 is a flowchart illustrating operations performed by an example user interface for remote operation of a sensing platform, in accordance with the techniques of the disclosure. In the example shown in FIG. 4, an event detection model is stored on a distant or space-based sensor platform, such as the satellite constellation 120 shown in FIGS. 1 and 2, and used to detect and send, to the user interface of user plug-in 128.2, notices of events seen in sensor data captured by satellite constellation 120 (400). A user reviews the notices and requests additional information on selected events from the list of detected events, which are then delivered via network 122 (402). A check is made to determine if there are any issues with the model (404). Issues may include increasing false positives, disagreements between models, need for a new model, etc. If changes are not needed, control returns to 400.

If, however, there are issues with the model, the model is revised. In one example approach, a user such as SITL may detect false positives in the events detected and notify the model of the false positives. The model then is redone at the sensing platform with the false positive event labeled as negative. On the other hand, a user may determine that a new model is needed and may prototype such a model before transmitting the prototype to the sensing platform. Once, however, the issue has been identified, notice of the issue is sent to the sensing platform for incorporation in its detection models (406).

As noted above, in some example approaches, a Figure of Merit (FOM) or other scoring type metric is calculated and used to prioritize data to be downloaded within the given interval. FOM may be used, for instance, to select intervals of sensor data that are retained at higher resolution for scientific study. In one example approach, neural network-based models are used to predict the Figure of Merit (FOM) categories that would be assigned to selected time periods of MMS data by SITLs; data at the point of collection may, therefore, be prioritized for selection based on the FOM.

In one example approach, a bi-LSTM-based model is trained to predict FOM scores of MMS data selections. In one such example approach, the predicted scores are then converted to one of four FOM categories. In another example approach, a multi-class classifier is trained to directly pick the FOM category. Both approaches exhibited confusion between the middle two FOM categories (FOM categories 2 and 3) but the multi-class classifier resulted in improved test prediction accuracy. There are several approaches to attempt to reduce this class confusion, such as by introducing class weights to penalize the model for overpredicting a single category to its current extent. The number of categories may also be expanded by for instance, expanding the category labels to include the plus and minus indicators described in the FOM category guidelines. The plus indicator signifies that the associated event should be given a score in the upper range of the specified category, so for example a category designation of 2+ could result in a FOM score of 145, whereas a designation of 2 should result in scores closer to the midpoint of 125. Similarly, the negative sign indicator suggests that those events should be assigned FOM scores in the lower range of the category. There are a significant number of data selections with scores near category boundaries, so it could be helpful to assign these examples as their own class.

There were clear differences in the FOM score distributions assigned to selected time periods by different SITL experts. This suggests that data selection models trained with selections made by one SITL may not accurately reproduce selections made by a different SITL, even for a single type of event like MP crossings. However, there is an insufficient quantity of examples in the 2017/2018 dataset to adequately model individual SITL selections. Instead, distinct subsets of multiple SITLs may be used as a conglomerate identity that does have sufficient selection examples for which to train a model. By training two such models, the models can then be tested on both test data subsets to determine if there is a statistically significant difference in their abilities to reproduce selections made by SITLs that were not included in their training dataset.

FIG. 5 illustrates a space-based sensing platform having a computing platform, in accordance with the techniques of the disclosure. In the example shown in FIG. 5, sensing platform 120 (e.g., an MMS satellite) includes a computing platform 500 connected via a network to ground station 114 and via a communications channel to satellite sensors 214.

As shown in the example of FIG. 5, computing platform 500 includes processing circuitry 205, one or more input components 213, one or more communication units 211, one or more output components 201, and one or more storage components 207. Communication channels 215 may interconnect each of the components 201, 203, 205, 207, 211, and 213 for inter-component communications (physically, communicatively, and/or operatively). In some examples, communication channels 215 may include a system bus, a network connection, an inter-process communication data structure, or any other method for communicating data.

In one example approach, processing circuitry 205 includes computing components of, for instance, a CubeSat or other embedded computing system that supports event detection operations and is designed for deployment in space. In another example approach, processing circuitry 205 includes either an Intel Movidius™ Myriad™ 2 Vision Processing Unit (VPU) or a Google Edge Tensor Processing Unit (TPU). Both the VPU and TPU are Application Specific Integrated Circuits (ASICs) that are designed to efficiently perform deep learning computations, so they are well suited for running MP event detection models. They are also commercial off-the-shelf (COTS) products designed for edge computing applications, meeting the Size, Weight, Power, and Cost (SWaP-C) requirements for in-situ operation. The VPU has already passed radiation exposure tests; the VPU meets power consumption requirements for operating in a spacecraft and has been demonstrated to perform machine learning operations onboard the PhiSat-1 satellite while orbiting Earth.

One or more communication units 211 of computing platform 500 may communicate with external devices, such ground station 114 and satellite constellation 120, via one or more wired and/or wireless networks by transmitting and/or receiving network signals on the one or more networks. Examples of communication units 211 include a network interface card (e.g., such as an Ethernet card), an optical transceiver, a radio frequency transceiver, a GPS receiver, or any other type of device that can send and/or receive information. Other examples of communication units 211 may include short wave radios, cellular data radios, wireless network radios, as well as universal serial bus (USB) controllers.

In one example approach, plugin software 128.2 operating on a terrestrial computing system receiving data from the ground station is connected to the PySPEDAS and/or EVA tools, which enable SITLs to interact with and configure the event detection tool. The User Plugin 128.2 is designed to present data selection models and prediction operations at any point in the workflow that experts find useful. SITLs receive data selection recommendations from the detection models and collaborate on training new event detection models, as well as confirming any necessary updates to existing models based on new findings. In some example approaches, feedback from scientists is used to iteratively improve the User Plugin component 128.2 and to determine preferred user experiences.

One or more input components 213 of computing platform 500 may receive sensor data captured by external sensors such as satellite constellation 120 and input such as tactile, audio, and video input. In some examples, input components 213 may include one or more sensor components one or more location sensors (GPS components, Wi-Fi components, cellular components), one or more temperature sensors, one or more movement sensors (e.g., accelerometers, gyroscopes), one or more pressure sensors (e.g., barometer), one or more electric or magnetic field sensors, one or more ambient light sensors, and one or more other sensors (e.g., microphone, camera, infrared proximity sensor, hygrometer, and the like).

One or more output components 201 of computing platform 500 may generate output. Examples of output include notices of event detection and sensor data at one or more resolution levels. In one example approach, Plug-in 128.2 displays received events on a display. In one such example approach, the stream of output results includes a line for each set of predictions for the example time sequence. The output is color-coded to indicate the accuracy of the predictions for that time sequence. Grey text indicates that true negatives are the predominant type of outcome. Green text indicates that true positives are the predominant prediction result. Yellow text indicates that most of the predictions were false positives, and red text signifies that most of the predictions were false negatives.

Processing circuitry 205 may implement functionality and/or execute instructions associated with computing platform 500. Examples of processing circuitry 205 include application processors, display controllers, auxiliary processors, one or more sensor hubs, and any other hardware configure to function as a processor, a processing unit, or a processing device. Processing circuitry 205 of computing platform 500 may retrieve and execute instructions stored by storage components 207 that cause processing circuitry 205 to perform operations for processing sensor data. The instructions, when executed by processing circuitry 205, may cause computing platform 500 to store information within storage components 207. In one example, storage components 207 include data cache 124.

One or more storage components 207 within computing platform 500 may store information for processing during operation of computing platform 500. In some examples, storage component 207 includes a temporary memory, meaning that a primary purpose of one example storage component 207 is not long-term storage. Storage components 207 on computing platform 500 may be configured for short-term storage of information in volatile memory and therefore not retain stored contents if powered off. Examples of volatile memories include random-access memories (RAM), dynamic random-access memories (DRAM), static random-access memories (SRAM), and other forms of volatile memories known in the art.

Storage components 207, in some examples, also include one or more computer-readable storage media. Storage components 207 in some examples include one or more non-transitory computer-readable storage mediums. Storage components 207 may be configured to store larger amounts of information than typically stored by volatile memory. Storage components 207 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 207 may store program instructions and/or information (e.g., data) associated with event modeling and detection. Storage components 207 may include a memory configured to store data or other information associated with event modeling and detection.

Clock 203 is a device that allows computing platform 500 to measure the passage of time (e.g., track system time). Clock 203 typically operates at a set frequency and measures a number of ticks that have transpired since some arbitrary starting date. Clock 203 may be implemented in hardware or software.

As noted above, in some example approaches, computing system 500 has limited processing capability. For instance, the event classifiers of the MMS system are trained on and perform on the constrained computing platforms of available on the remote sensor platforms. In one example approach, reduced precision in parameter and activation values represented in QNN modeling enables the sensor platform to perform multiple neural network processing steps with a single computing instruction. One method of achieving this data parallelism is by vectorizing neural network training and inference steps to utilize Single Instruction Multiple Data (SIMD) operations that are available on CPUs and on other computing architectures. For example, in the case of processing binary QNN representations with 64-bit architectures, 64 node activations may be computed in a single bitwise-or operation.

Processing may be further accelerated by performing SIMD operations concurrently on multiple computing units or devices, such as across CPU cores, CUDA cores, and tensor cores (e.g., TPUs). Race conditions should be avoided by appropriately structuring parallel processing pipelines for QNN training and inference steps. For example, during training the Straight Through Estimator (STE) error gradients may safely be computed in parallel for all predictions from a given batch of training examples. The cumulative error is then found and used to update network parameters for the next batch. The BMXNet library enables implementing and testing QNN models with these forms of data and process parallelism.

In one example approach, one may measure runtimes, estimate energy usage, and compute degree of parallelization achieved for an example event detection pipeline, including sensor data sampling, quantization, model training, and inference operations. Compact computing platforms, such as Raspberry Pi 2 and Raspberry Pi 4 devices, may be used to test performance on embedded computing systems with disparate computing capabilities and memory resources. Similarly, GPU acceleration may be tested for each operation using Nvidia devices, which are supported by the MXNet framework. Based on the results of these tests, one may develop plans to incorporate support for additional computing hardware types and vendors, such as by using the OpenVINO ML library for heterogenous computing.

It can be difficult to provide sufficient data quantity and bandwidth for tests on embedded systems, and to take advantage of SIMD operations to parallelize processing of quantized data samples. One may mitigate these risks by using large flash memory cards for the Raspberry Pi internal storage during tests, and, possibly, varying the size of training datasets to differentiate memory-limited versus compute-limited test conditions. Further, theoretical parallelization levels may be estimated for each data precision level and compared to computed levels based on measured performance to understand the potential for improving initial results. Decision support tool 128 may be used within NASA and other federal, state, and local agencies in projects having workflows that benefit from prioritizing, down-selecting, or summarizing sensor outputs to derive increased value. As noted above, Figure of Merit (FOM) or other scoring type metrics may be used to prioritize data downloads.

In addition, decision support tool 128 may be used, for example, to improve data collection and to automate and enhance event detection in Earth-observing, atmospheric, and magnetospheric survey missions and in studies of our solar system. Potential applications include future iterations of HSO missions that are similar to observatories such as MMS, WIND, THEMIS, Cluster II, STEREO, and the Europa Lander. In addition, decision support tool 128 has application in Geographic Information Systems (GIS).

Furthermore, long-running surveillance operations, including law enforcement, energy and utility monitoring, as well as security systems, may employ the event detection capabilities of decision support tool 128 to reduce manual effort and to quickly identify time-critical events at the point of occurrence to improve incident response time. A recent market forecast by Allied Market Research estimated that “the global commercial satellite imaging market was valued at $2.2 billion in 2018, and is expected to reach $5.3 billion by 2026, registering a CAGR of 11.2% from 2019 to 2026.” Currently, there is limited use of AI-based selection methods at the point of collection, such as on-board spacecraft.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

The techniques described in this disclosure may also be embodied or encoded in a computer-readable medium, such as a computer-readable storage medium, containing instructions. Instructions embedded or encoded in a computer-readable storage medium may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

What is claimed is:

1. A sensor platform comprising:
a memory, the memory storing instructions for generating event detection models used to detect events in captured sensor data;
a sensor interface communicatively coupled to the memory, the sensor interface configured to capture data received from sensors connected to the sensor interface and to store the captured sensor data in the memory; and
one or more processors communicatively coupled to the memory, the processors configured to execute instructions stored in the memory, the instructions when executed causing the processors to:
generate and train an event detection model from the instructions;
retrieve the captured sensor data from memory;
apply the trained event detection model to the captured sensor data, the trained event detection model configured to detect an event from within the captured sensor data;
transmit notice of the detected event to a remote observer; and
transmit captured sensor data associated with the detected event in response to a request from the remote observer for sensor data corresponding to the detected event.

2. The sensor platform of claim 1, wherein the instructions that when executed cause the processors to transmit notice of the detected event to a remote observer further include instructions that when executed cause the processors to associate portions of the captured sensor data with the detected event and to transmit a lower resolution version of the portions of captured sensor data associated the detected event to the remote observer.

3. The sensor platform of claim 1, wherein the processor is further configured to execute instructions stored in the memory that, when executed, cause the processors to:
determine that one of the event detection models needs retraining; and
retrain the event detection model.

4. A method, comprising:
receiving captured sensor data at a remote location;
generating and training, at the remote location, an event detection model, the trained event detection model configured to detect an event from within the captured sensor data;
applying the trained event detection model at the remote location to the captured sensor data to detect an event from within the captured sensor data;
transmitting notice of the detected event to a remote observer; and
transmitting captured sensor data associated with the detected event to the remote observer in response to a request from the remote observer for some or all of the sensor data associated with to the detected event.

5. The method of claim 4, wherein transmitting notice of the detected event to a remote observer includes associating portions of the captured sensor data with the detected event and transmitting a lower resolution version of the portions of captured sensor data associated the detected event to the remote observer.

6. The method of claim 4, wherein the method further comprises:
determine that one of the event detection models needs retraining; and
retrain the event detection model.

7. A non-transitory computer-readable storage medium comprising instructions that, when executed, cause one or more processors of a sensor platform to:
receive captured sensor data;
generate and train an event detection model, the trained event detection model configured to detect an event from within the captured sensor data from the instructions;
apply the trained event detection model to the captured sensor data to detect an event from within the captured sensor data;
transmit notice of the detected event to a remote observer; and
transmit captured sensor data associated with the detected event to the remote observer in response to a request from the remote observer for some or all of the sensor data associated with to the detected event.

8. The non-transitory computer-readable storage medium of claim 7, wherein transmitting notice of the detected event to a remote observer includes associating portions of the captured sensor data with the detected event and transmitting a lower resolution version of the portions of captured sensor data associated the detected event to the remote observer with the notice.

9. A sensor system, comprising:
a sensor platform;
an observer station remote from the sensor platform; and
a communications channel connected to the sensor platform and the observer station,
wherein the sensor platform includes:
a memory, the memory storing instructions for generating event detection models used to detect events in the captured sensor data;
an interface, the interface configured to receive captured sensor data and store the captured sensor data to memory; and
one or more processors communicatively coupled to the memory, the processors configured to execute instructions stored in the memory, the instructions when executed causing the one or more processors to:
generate and train an event detection model from the instructions;
retrieve the captured sensor data from memory;
apply the trained event detection model to the captured sensor data, the trained event detection model configured to detect an event from within the captured sensor data;
transmit notice of the detected event to a remote observer; and
transmit captured sensor data associated with the detected event to the remote observer in response to a request from the remote observer for some or all of the sensor data associated with to the detected event.

10. The system of claim 9, wherein the instructions that when executed cause the one or more processors to transmit notice of the detected event to a remote observer further include instructions that when executed cause the processors to associate portions of the captured sensor data with the detected event and to transmit a lower resolution version of the portions of captured sensor data associated the detected event to the remote observer with the notice.

11. The system of claim 9, wherein the one or more of the processors are further configured to execute instructions stored in the memory that, when executed, cause the processors to:
determine that one of the event detection models needs retraining; and
retrain the event detection model.

12. The system of claim 9, wherein the observer station comprises:
a memory, the memory storing instructions for generating event detection models used to detect events in the captured sensor data; and
one or more processors communicatively coupled to the memory, the processors configured to execute instructions stored in the memory, the instructions when executed causing the one or more processors to:
receive the notices of detected events from the sensor platform; and
request sensor data corresponding to one or more of the detected events.

13. The system of claim 12, wherein the observer station further comprises a user interface, the user interface configured to receive the notices of detected events and to select one or more of the detected events for review of the sensor data corresponding to the event.

14. The system of claim 13, wherein the user interface is further configured to notify the sensor platform of the selected events.

15. The system of claim 13, wherein the observer station further comprises a model tracker, the model tracker configured to enable a user to detect false positives in detected events and to notify the sensor platform of the false positives.

16. The system of claim 13, wherein the observer station further comprises an event prototyper, wherein the event prototyper is configured to enable a user to prototype new event detection models.

17. The system of claim 13, wherein the observer station further comprises a model tracker, the model tracker configured to:
identify new types of interesting events in captured sensor data; and
label relevant time intervals as an example of the event; and
wherein the sensor platform further comprises an event modeling application, the event modeling application configured to receive the labeled time intervals from the observer station and to train a new detection model based on the captured sensor data from the labeled time intervals.
